(19) United States
(12) Patent Application Publication
(10) Pub. No.: US 2011/0205155 A1
(43) Pub. Date: Aug. 25, 2011

(54) Methods and Systems for Position Detection Using an Interactive Volume

(76) Inventors: John David Newton, Auckland (NZ); Bo Li, Auckland (NZ); Gordon MacDonald, Auckland (NZ); Brody Radford, Auckland (NZ); Brendon Port, Auckland (NZ); Hubert Jetschko, Auckland (NZ); Rui Zhang, Auckland (NZ); Francois Goffinet, Auckland (NZ)

(21) Appl. No.: 12/960,759

(22) Filed: Dec. 6, 2010

(30) Foreign Application Priority Data
Dec. 4, 2009 (AU) 2009905917
Feb. 23, 2010 (AU) 2010900748
Jun. 21, 2010 (AU) 2010902689

(51) Int. Cl. G06F 3/033; G09G 5/00

(52) U.S. Cl. 345/157; 345/156

(57) ABSTRACT

A computing device, such as a desktop, laptop, tablet computer, a mobile device, or a computing device integrated into another device (e.g., an entertainment device for gaming, a television, an appliance, kiosk, vehicle, tool, etc.) is configured to determine user input commands from the location and/or movement of one or more objects in a space. The object(s) can be imaged using one or more optical sensors and the resulting position data can be interpreted in any number of ways to determine a command. An interactive volume can be defined and adjusted so that the same movement at different locations within the volume may result in different corresponding movement of a cursor or other interpretations of input.

### PRIORITY CLAIM

The present application claims priority to Australian Provisional Application No. 2009905917, filed Dec. 4, 2009 and entitled, “A Coordinate Input Device,” which is incorporated by reference herein in its entirety; the present application also claims priority to Australian Provisional Application No. 2010900748, filed Feb. 23, 2010 and entitled, “A Coordinate Input Device,” which is incorporated by reference herein in its entirety; the present application also claims priority to Australian Provisional Application No. 2010902689, filed Jun. 21, 2010 and entitled, “3D Computer Input System,” which is incorporated by reference herein in its entirety.

### CROSS-REFERENCE TO RELATED APPLICATIONS

This application is related to the following U.S. patent applications filed on the same day as the present application and naming the same inventors as the present application, and each of the following applications is incorporated by reference herein in its entirety: “Methods and Systems for Position Detection” (Attorney Docket 58845-398806); “Imaging Methods and Systems for Position Detection” (Attorney Docket 58845-398807); and “Sensor Methods and Systems for Position Detection” (Attorney Docket 58845-398808).

### BACKGROUND

Touch-enabled computing devices have become increasingly popular. Such devices can use optical, resistive, and/or capacitive sensors to determine when a finger, stylus, or other object has approached or touched a touch surface, such as a display. The use of touch has allowed for a variety of interface options, such as so-called “gestures” based on tracking touches over time.

Despite the advantages of touch-enabled systems, drawbacks remain. Laptop and desktop computers benefit from touch-enabled screens, but the particular configuration or arrangement of the screen may require a user to reach or otherwise move in an uncomfortable manner. Additionally, some touch detection technologies remain expensive, particularly for larger screen areas.

### SUMMARY

Embodiments of the present subject matter include a computing device, such as a desktop, laptop, tablet computer, a mobile device, or a computing device integrated into another device (e.g., an entertainment device for gaming, a television, an appliance, kiosk, vehicle, tool, etc.). The computing device is configured to determine user input commands from the location and/or movement of one or more objects in a space. The object(s) can be imaged using one or more optical sensors and the resulting position data can be interpreted in any number of ways to determine a command.

The commands include, but are not limited to, graphical user interface events within two-dimensional, three-dimensional, and other graphical user interfaces. As an example, an object such as a finger or stylus can be used to select on-screen items by touching a surface at a location mapped to the on-screen item or hovering over the surface near the location. As a further example, the commands may relate to non-graphical events (e.g., changing speaker volume, activating/deactivating a device or feature, etc.). Some embodiments may rely on other input in addition to the position data, such as a click of a physical button provided while a finger or object is at a given location.

However, the same system may be able to interpret other input that does not feature a touch. For instance, the finger or stylus may be moved in a pattern that is then recognized as a particular input command, such as a gesture that is recognized based on or more heuristics that correlate the pattern of movement to particular commands. As another example, movement of the finger or stylus in free space may translate to movement in the graphical user interface. For instance, crossing a plane or reaching a specified area may be interpreted as a touch or selection action, even if nothing is physically touched.

The object's location in space may influence how the object's position is interpreted as a command. For instance, a movement of an object within one part of the space may result in a different command than an identical movement of the object within another part of the space.

As an example, a finger or stylus may be moved along one or two axes within the space (e.g., along a width and/or height of the space), with the movement in the one or two axes resulting in corresponding movement of the cursor in a graphical user interface. The same movement at different locations along a third axis (e.g., at a different depth) may result in different corresponding movement of the cursor. For instance, a left-to-right movement of a finger may result in faster movement of the cursor the farther the finger is from a screen of the device. This can be achieved in some embodiments by using a virtual volume (referred to as an “interactive volume” herein) defined by a mapping of space coordinates to screen/interface coordinates, with the mapping varying along the depth of the interactive volume.

As another example, different zones may be used for different types of input. In some embodiments, a first zone can be defined near a screen of the device and a second zone can be defined elsewhere. For instance, the second zone may lie between the screen and keys of a keyboard of a laptop computer, or may represent imagable space outside the first zone in the case of a tablet or mobile device. Input in the first zone may be interpreted as touch, hover, and other graphical user interface commands. Input in the second zone may be interpreted as gestures. For instance, a “flick” gesture may be provided in the second zone in order to move through a list of items, without need to select particular items/command buttons via the graphical user interface.

As discussed below, aspects of various embodiments also include irradiation, detection, and device configurations that allow for image-based input to be provided in a responsive and accurate manner. For instance, detector configuration and detector sampling can be used to provide higher image processing throughput and more responsive detection. In some embodiments, fewer than all available pixels from the detector are sampled, such as by limiting the pixels to a projection of an interactive volume and/or determining an area of interest for detection by one detector of a feature detected by a second detector.

These illustrative embodiments are mentioned not to limit or define the limits of the present subject matter, but to provide examples to aid understanding thereof. Illustrative embodiments are discussed in the Detailed Description, and further description is provided there, including illustrative embodiments of systems, methods, and computer-readable media providing one or more aspects of the present subject matter. Advantages offered by various embodiments may be further understood by examining this specification and/or by practicing one or more embodiments of the claimed subject matter.

### BRIEF DESCRIPTION OF THE DRAWINGS

A full and enabling disclosure is set forth more particularly in the remainder of the specification. The specification makes reference to the following appended figures.

FIGS. 1A-1D illustrate exemplary embodiments of a position detection system.

FIG. 2 is a diagram showing division of an imaged space into a plurality of zones.

FIG. 3 is a flowchart showing an example of handling input based on zone identification.

FIG. 4 is a diagram showing an exemplary sensor configuration for providing zone-based detection capabilities.

FIG. 5 is a cross-sectional view of an illustrative architecture for an optical unit.

FIG. 6 is a diagram illustrating use of a CMOS-based sensing device in a position detection system.

FIG. 7 is a circuit diagram illustrating one illustrative readout circuit for use in subtracting one image from another in hardware.

FIGS. 8 and 9 are exemplary timing diagrams illustrating use of a sensor having hardware for subtracting a first and second image.

FIG. 10 is a flowchart showing steps in an exemplary method for detecting one or more space coordinates.

FIG. 11 is a diagram showing an illustrative hardware configuration and corresponding coordinate systems used in determining one or more space coordinates.

FIGS. 12 and 13 are diagrams showing use of a plurality of imaging devices to determine a space coordinate.

FIG. 14 is a flowchart and accompanying diagram showing an illustrative method of identifying a feature in an image.

FIG. 15A is a diagram of an illustrative system using an interactive volume.

FIGS. 15B-15E show examples of different cursor responses based on a variance in mapping along the depth of the interactive volume.

FIG. 16 is a diagram showing an example of a user interface for configuring an interactive volume.

FIGS. 17A-17B illustrate techniques in limiting the pixels used in detection and/or image processing.

FIG. 18 shows an example of determining a space coordinate using an image from a single camera.

### DETAILED DESCRIPTION

Reference will now be made in detail to various and alternative exemplary embodiments and to the accompanying drawings. Each example is provided by way of explanation, and not as a limitation. It will be apparent to those skilled in the art that modifications and variations can be made. For instance, features illustrated or described as part of one embodiment may be used on another embodiment to yield a still further embodiment. Thus, it is intended that this disclosure includes modifications and variations as come within the scope of the appended claims and their equivalents.

In the following detailed description, numerous specific details are set forth to provide a thorough understanding of the claimed subject matter. However, it will be understood by those skilled in the art that claimed subject matter may be practiced without these specific details. In other instances, methods, apparatuses or systems that would be known by one of ordinary skill have not been described in detail so as not to obscure the claimed subject matter.

### Illustrative System and Hardware Aspects of Position Detection Systems

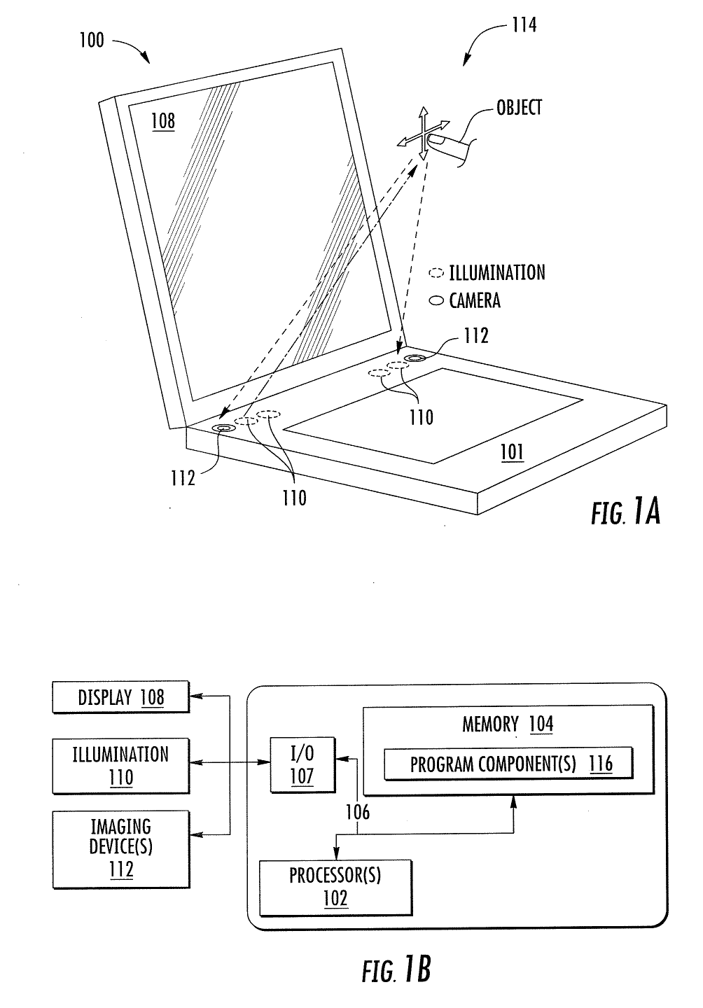

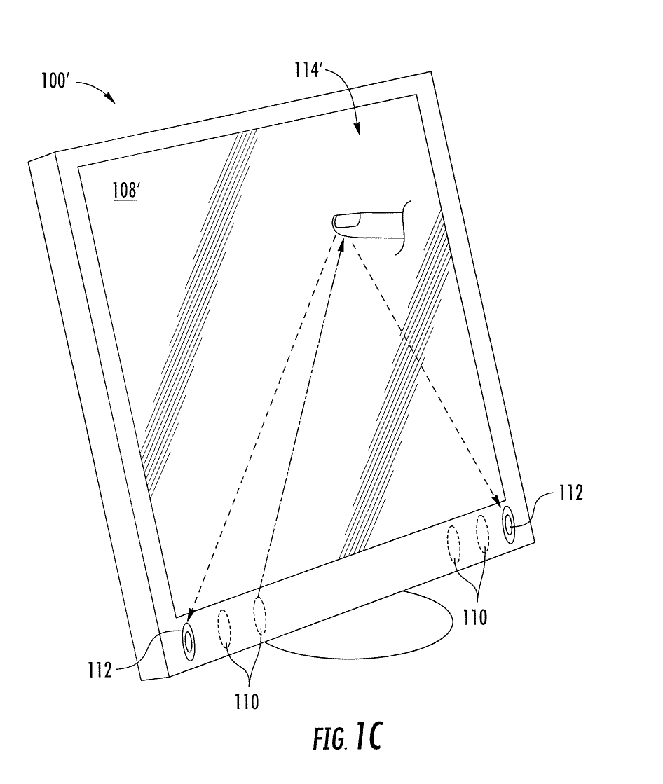

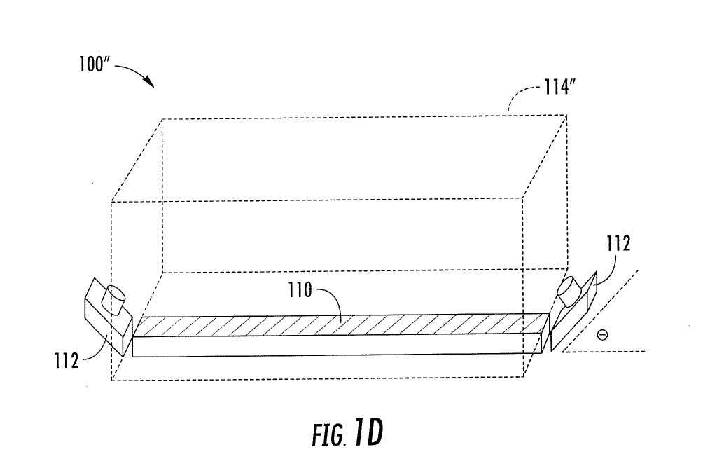

FIG. 1A is a view of an illustrative position detection system 100, while FIG. 1B is a diagram showing an exemplary architecture for system 100. Generally, a position detection system can comprise one or more imaging devices and hardware logic that configures the position detection system access data from the at least one imaging device, the data comprising image data of an object in the space, access data defining an interactive volume within the space, determine a space coordinate associated with the object, and determine a command based on the space coordinate and the interactive volume.

In this example, the position detection system is a computing system in which the hardware logic comprises a processor 102 interfaced to a memory 104 via bus 106. Program components 116 configure the processor to access data and determine the command. Although a software-based implementation is shown here, the position detection system could use other hardware (e.g., field programmable gate arrays (FPGA), programmable logic arrays (PLA), etc.).

Returning to FIG. 1, memory 104 can comprise RAM, ROM, or other memory accessible by processor 102 and/or another non-transitory computer-readable medium, such as a storage medium. System 100 in this example is interfaced via I/O components 107 to a display 108, a plurality of irradiation devices 110, and a plurality of imaging devices 112. Imaging devices 112 are configured to image a field of view including space 114.

In this example, multiple irradiation and imaging devices are used, though it will be understood that a single imaging device could be used in some embodiments, and some embodiments could use a single irradiation device or could omit an irradiation device and rely on ambient light or other ambient energy. Additionally, although several examples herein use two imaging devices, a system could utilize more than two imaging devices in imaging an object and/or could use multiple different imaging systems for different purposes.

Memory 104 embodies one or more program components 116 that configure the computing system to access data from the imaging device(s) 112, the data comprising image data of one or more objects in the space, determine a space coordinate associated with the one or more objects, and determine a command based on the space coordinate. Exemplary configuration of the program component(s) will be discussed in the examples below.

The architecture of system 100 shown in FIG. 1B is not meant to be limiting. For example, one or more I/O interfaces 107 comprising a graphics interface (e.g., VGA, HDMI) can be used to connect display 108 (if used). Other examples of I/O interfaces include universal serial bus (USB), IEEE 1394, and internal busses. One or more networking components for communicating via wired or wireless communication can be used, and can include interfaces such as Ethernet, IEEE 802.11 (Wi-Fi), 802.16 (Wi-Max), Bluetooth, infrared, etc., CDMA, GSM, UMTS, or other cellular communication networks.

FIG. 1A illustrates a laptop or netbook form factor. In this example, irradiation and imaging devices 110 and 112 are shown in body 101, which may also include the processor, memory, etc. However, any such components could be included in display 108.

For example, FIG. 1C shows another illustrative form factor of a position detection system 100′. In this example, a display device 108′ has integrated irradiation devices 110 and imaging devices 112 in a raised area at the bottom of the screen. The area may be approximately 2 mm in size. In this example, the imaging devices image a space 114′ including the front area of display device 108′. Display device 108′ can be interfaced to a computing system (not shown) including a processor, memory, etc. As another example, the processor and additional components could be included in the body of display 108′. Although shown as a display device (e.g., an LCD, plasma, OLED monitor, television, etc.), the principles could be applied for other devices, such as tablet computers, mobile devices, and the like.

FIG. 1D shows another illustrative position detection system 100″. In particular, imaging devices 112 can be positioned either side of an elongated irradiation device 110, which may comprise one or more light emitting diodes or other devices that emit light. In this example, space 114″ includes a space above irradiation device 110 and between imaging devices 112. In this example the image plane of each imaging device lies at an angle Θ between the bottom plane of space 114″, and Θ can be equal or approximately equal to 45 degrees in some embodiments. Although shown here as a rectangular space, the actual size and extent of the space can depend upon the position, orientation, and capabilities of the imaging devices.

Additionally, depending upon the particular form factor, irradiation device 110 may not be centered on space 114″. For example, if irradiation device 110 and imaging devices 112 are used with a laptop computer, they may be positioned approximately near the top or bottom of the keyboard, with space 114″ corresponding to an area between the screen and keyboard. Irradiation device 110 and imaging devices 112 could be included in or mounted to a keyboard positioned in front of a separate screen as well. As a further example, irradiation device 110 and imaging devices 112 could be included in or attached to a screen or tablet computer. Still further, irradiation device 110 and imaging devices 112 may be included in a separate body mounted to another device or used as a standalone peripheral with or without a screen.

As yet another example, imaging devices 112 could be provided separately from irradiation device 110. For instance, imaging devices 112 could be positioned on either side of a keyboard, display screen, or simply on either side of an area in which spatial input is to be provided. Irradiation device(s) 110 could be positioned at any suitable location to provide irradiation as needed.

Generally speaking, imaging devices 112 can comprise area sensors that capture one or more frames depicting the field of view of the imaging devices. The images in the frames may comprise any representation that can be obtained using imaging units, and for example may depict a visual representation of the field of view, a representation of the intensity of light in the field of view, or another representation. The processor or other hardware logic of the position detection system can use the frame(s) to determine information about one or more objects in space 114, such as the location, orientation, direction of the object(s) and/or parts thereof. When an object is in the field of view, one or more features of the object can be identified and used to determine a coordinate within space 114 (i.e., a “space coordinate”). The computing system can determine one or more commands based on the value of the space coordinate. In some embodiments, the space coordinate is used in determining how to identify a particular command by using the space coordinate to determine a position, orientation, and/or movement of the object (or recognized feature of the object) over time.

### Illustrative Embodiments Featuring Multiple Detection Zones

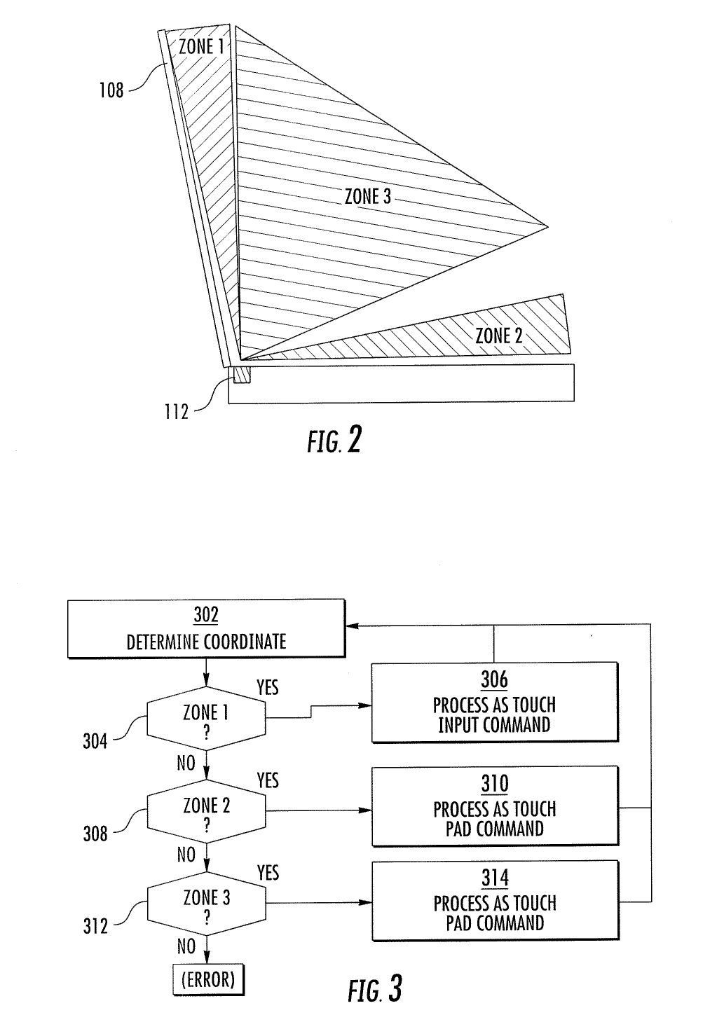

In some embodiments, different ranges of space coordinates are treated differently in determining a command. For instance, as shown in FIG. 2 the imaged space can be divided into a plurality of zones. This example shows an imaging device 112 and three zones, though more or fewer zones may be defined; additionally, the zones may vary along the length, width, and/or depth of the imaged space. An input command can be identified based on determining which one of a plurality of zones within the space contains the determined space coordinate. For example, if a coordinate lies in the zone (“Zone 1”) proximate the display device 108, then the movement/position of the object associated with that coordinate can provide different input than if the coordinate were in Zones 2 or 3.

In some embodiments, the same imaging system can be used to determine a position component regardless of the zone in which the coordinate lies. However, in some embodiments multiple imaging systems are used to determine inputs. For example, one or more imaging devices 112 further from the screen can be used to image zones 2 and/or 3. In one example, each imaging system passes a screen coordinate to a routine that determines a command in accordance with FIG. 3.

For example, for commands in zone 1, one or more line or area sensors could be used to image the area at or around the screen, with a second system used for imaging one or both of zones 2 zone 3. If the second system images only one of zones 2 and 3, a third imaging system can image the other of zones 2 and 3. The imaging systems could each rely on one or more aspects described below to determine a space coordinate. Of course, multiple imaging systems could be used within one or more of the zones. For example, zone 3 may be handled as a plurality of sub-zones, with each sub-zone imaged by a respective set of imaging devices. Zone coverage may overlap, as well.

The same or different position detection techniques could be used in conjunction with the various imaging systems. For example, the imaging system for zone 1 could use triangulation principles to determine coordinates relative to the screen area, or each imaging system could use aspects of the position detection techniques noted herein. That same system could also determine distance from the screen. Additionally or alternatively, the systems could be used cooperatively. For example, the imaging system used to determine a coordinate in zone 1 could use triangulation for the screen coordinate and rely upon data from the imaging system used to image zone 3 in order to determine a distance from the screen.

FIG. 3 is a flowchart showing an example of handling the input based on zone identification and can be carried out by program components 116 shown in FIG. 1 or by other hardware/software used to implement the position detection system. Block 302 represents determining one or more coordinates in the space. For example, as noted below a space coordinate associated with a feature of an object, such as a fingertip, point of a stylus, etc. can be identified by analyzing the location of the feature as depicted in images captured by different imaging devices 112 and the known geometry of the imaging devices.

As shown at block 304, the routine can determine if the coordinate lies in zone 1 and, if so, use the coordinate in a determining touch input command as shown at 306. For example, the touch input command may be identified using a routine that provides an input event such as a selection in a graphical user interface based on a mapping of space coordinates to screen coordinates. As a particular example, a click or other selection may be registered when the object touches or approaches a plane corresponding to the plane of the display. Additional examples of touch detection are discussed later below in conjunction with FIG. 18. Any of the examples discussed herein can respond to 2D touch inputs (e.g., identified by one or more contacts between an object and a surface of interest) as well as 3D coordinate inputs.

Returning to FIG. 3, Block 308 represents determining if the coordinate lies in Zone 2. If so, flow proceeds to block 310. In this example, Zone 2 lies proximate the keyboard/trackpad and therefore coordinates in zone 2 are used in determining touch pad commands. For example, a set of 2-dimensional input gestures analogous to those associated with touch displays may be associated with the keyboard or trackpad. The gestures may be made during contact with the key(s) or trackpad or may occur near the keys or trackpad. Examples include, but are not limited to, finger waves, swipes, drags, and the like. Coordinate values can be tracked over time and one or more heuristics can be used to determine an intended gesture. The heuristics may identify one or more positions or points which, depending upon the gesture, may need to be identified in sequence. By matching patterns of movement and/or positions, the gesture can be identified. As another example, finger motion may be tracked and used to manipulate an on-screen cursor.

Block 312 represents determining if the coordinate value lies in Zone 3. In this example, if the coordinate does not lie in any of the zones an error condition is defined, though a zone could be assigned by default in some embodiments or the coordinate could be ignored. However, if the coordinate does lay in Zone 3, then as shown at block 314 the coordinate is used to determine a three-dimensional gesture. Similarly to identifying two-dimensional gestures, three-dimensional gestures can be identified by tracking coordinate values over time and applying one or more heuristics in order to identify an intended input.

As another example, pattern recognition techniques could be applied to recognize gestures, even without relying directly on coordinates. For instance, the system could be configured to identify edges of a hand or other object in the area and perform edge analysis to determine a posture, orientation, and/or shape of a hand or other object. Suitable gesture recognition heuristics could be applied to recognize various input gestures based on changes in the recognized posture, orientation, and/or shape over time.

FIG. 4 is a diagram showing an exemplary configuration for providing zone-based detection capabilities. In this example, an imaging device features an array 402 of pixels that includes portions corresponding to each zone of detection; three zones are shown here. Selection logic 404 can be used to sample pixel values and to provide the pixel values to an onboard controller 406 that formats/routes the data accordingly (e.g., via a USB interface in some embodiments). In some embodiments, array 402 is steerable to adjust at least one of a field of view or a focus to include an identified one of the plurality of zones. For example, the entire array or subsections thereof may be rotated and/or translated through use of suitable mechanical elements (e.g. micro electromechanical systems (MEMS) devices, etc.) in response to signals from selection logic 404. As another example, the entire optical unit may be repositioned using a motor, hydraulic system, etc. rather than steering the sensor array or portions thereof.

### Illustrative Embodiments of Imaging Devices

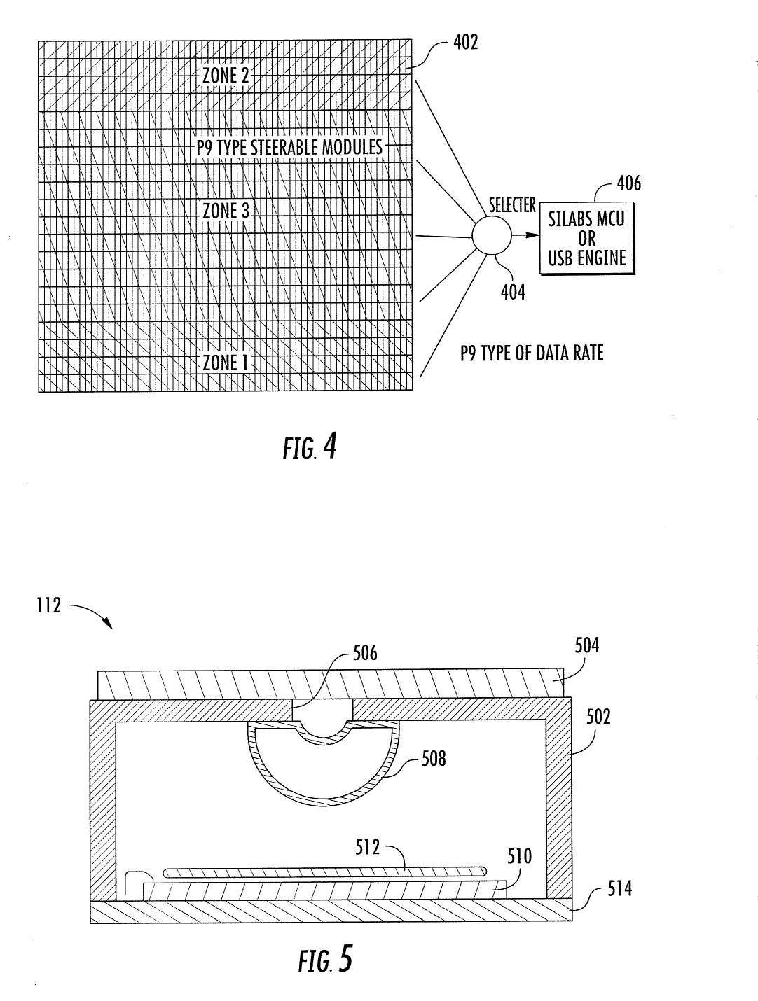

FIG. 5 is a cross-sectional view of an illustrative architecture for an optical unit 112 that can be used in a position detection system. In this example the optical unit includes a housing 502 made of plastic or another suitable material and a cover 504. Cover 504 may comprise glass, plastic, or the like and includes at least a transparent portion over and/or in aperture 506. Light passes through aperture 506 to lens 508, which focuses light onto array 510, in this example through a filter 512. Array 510 and housing 502 are mounted to frame 514 in this example. For instance, frame 514 may comprise a printed circuit board in some embodiments. In any event, array 510 can comprise one or more arrays of pixels configured to provide image data. For example, if IR light is provided by an irradiation system, the array can capture an image by sensing IR light from the imaged space. As another example, ambient light or another wavelength range could be used.

In some embodiments, filter 512 is used to filter out one or more wavelength ranges of light to improve detection of other range(s) of light used in capturing images. For example, in one embodiment filter 512 comprises a narrowband IR-pass filter to attenuate ambient light other than the intended wavelength(s) of IR before reaching array 510, which is configured to sense at least IR wavelengths. As another example, if other wavelengths are of interest a suitable filter 512 can be configured to exclude ranges not of interest.

Some embodiments utilize an irradiation system that uses one or more irradiation devices such as light emitting diodes (LEDs) to radiate energy (e.g., infrared (IR) ‘light’) over one or more specified wavelength ranges. This can aid in increasing the signal to noise ratio (SNR), where the signal is the irradiated portion of the image and the noise is largely comprised of ambient light. For example, IR LEDs can be driven by a suitable signal to irradiate the space imaged by the imaging device(s) that capture one or more image frames used in position detection. In some embodiments, the irradiation is modulated, such as by driving the irradiation devices at a known frequency. Image frames can be captured based on the timing of the modulation.

Some embodiments use software filtering to eliminate background light by subtracting images, such as by capturing a first image when irradiation is provided and then capturing a second image without irradiation. The second image can be subtracted from the first and then the resulting “representative image” can be used for further processing. Mathematically, the operation can be expressed as Signal=(Signal+Noise)−Noise. Some embodiments improve SNR with high-intensity illuminating light such that any noise is swamped/dwarfed. Mathematically, such situations can be described as Signal=Signal+Noise, where Signal>>Noise.

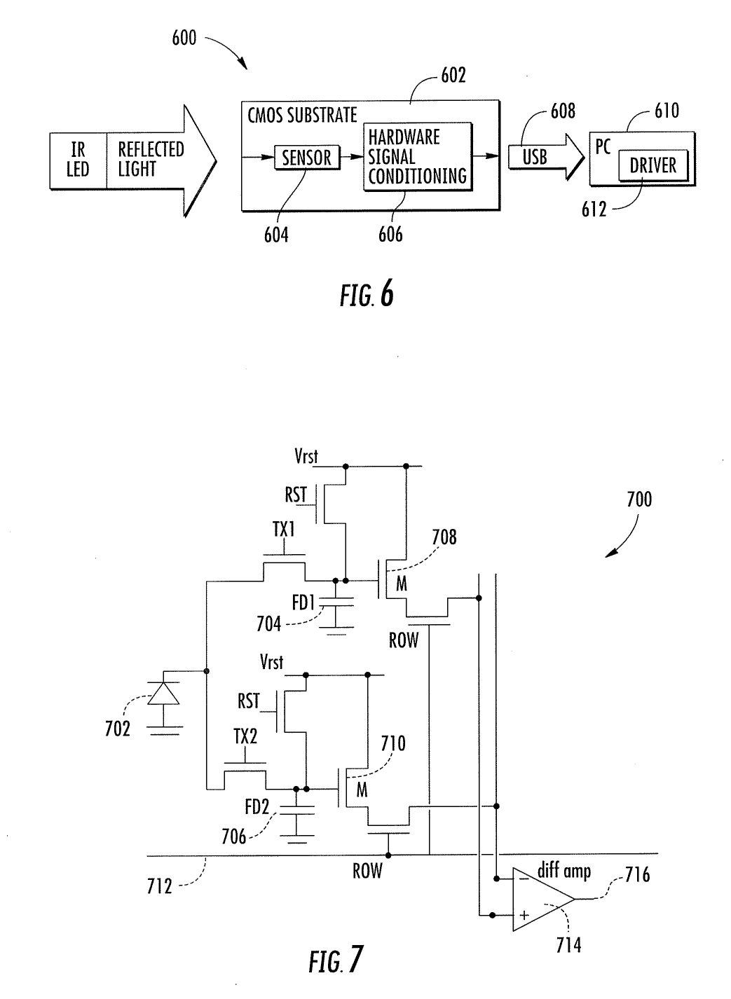

As shown in FIG. 6 some embodiments include hardware signal conditioning. FIG. 6 is a diagram 600 illustrating use of a CMOS-based sensing device 602 in a position detection system. In this example, sensor 604 comprises an array of pixels. CMOS substrate 602 also includes signal conditioning logic (or a programmable CPU) 606 that can be used to facilitate detection by performing at least some image processing in hardware before the image is provided by the imaging device, such as by a hardware-implemented ambient subtraction, infinite impulse response (IIR) or finite impulse response (FIR) filtering, background-tracker-based touch detection, or the like. In this example, substrate 602 also includes logic to provide a USB output that is used to deliver the image to a computing device 610. A driver 612 embodied in memory of computing device 610 configures computing device 610 to process images to determine one or more commands based on the image data. Although shown together in FIG. 6, components 604 and 606 may be physically separate, and 606 may be implemented in an FPGA, DSP, ASIC, or microprocessor. Although CMOS is discussed in this example, a sensing device could be implemented using any other suitable technology for constructing integrated circuits.

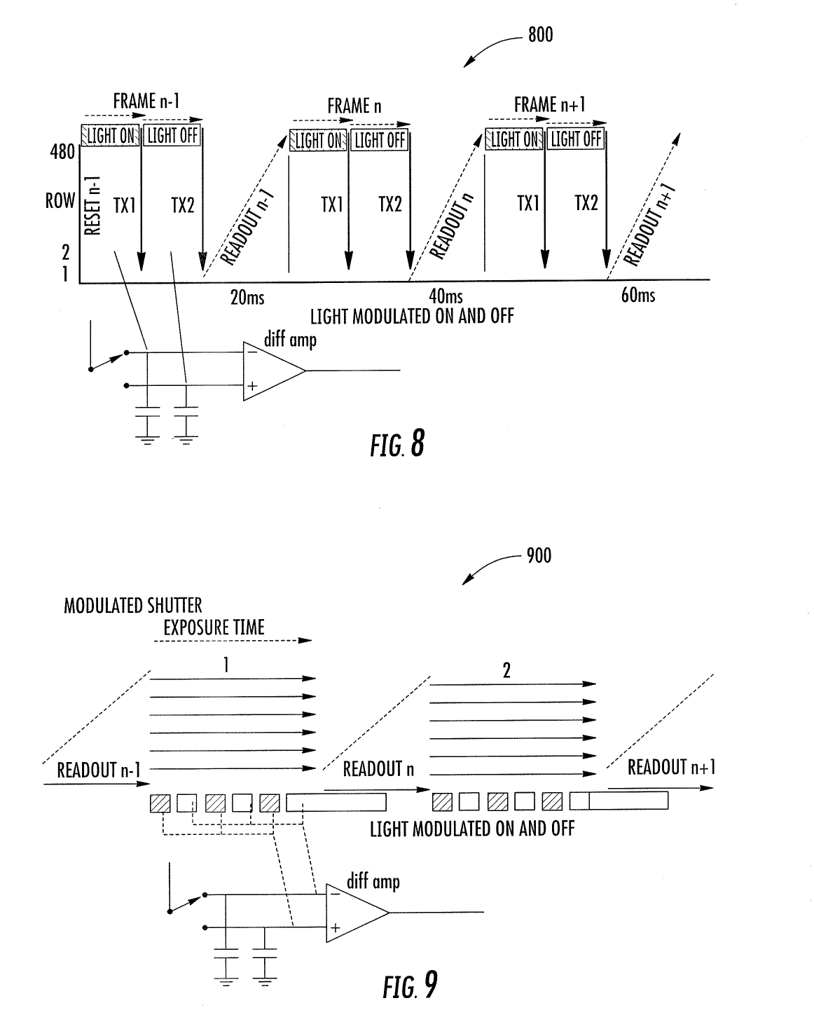

FIG. 7 is a circuit diagram 700 illustrating one example of a readout circuit for use in subtracting one image from another in hardware. Such a circuit could be comprised in a position detection system. In particular, a pixel 702 can be sampled using on two different storage devices 704 and 706 (capacitors FD1 and FD2 in this example) by driving select transistors TX1 and TX2, respectively. Buffer transistors 708 and 710 can then provide readout values when row select line 712 is driven, with the readout values provided to a differential amplifier 714. The output 716 of amplifier 714 represents the difference between the pixel as sampled when TX1 is driven and the pixel as sampled when TX2 is driven.

A single pixel is shown here, though it will be understood that each pixel in a row of pixels could be configured with a corresponding readout circuit, with the pixels included in a row or area sensor. Additionally, other suitable circuits could be configured whereby two (or more) pixel values can be retained using a suitable charge storage device or buffer arrangement for use in outputting a representative image or for applying another signal processing effect.

FIG. 8 is a timing diagram 800 showing an example of sampling (by a position detection system) the pixels during a first and second time interval and taking a difference of the pixels to output a representative image. As can be seen here, three successive frames (Frame n−1; Frame n; and Frame n+1) are sampled and output as representative images. Each row 1 through 480 is read over a time interval during which the irradiation is provided (“light on”) (e.g., by driving TX1) and then read again not while light is not provided (“light off”) (e.g. by driving TX2). Then, a single output image can be provided. This method parallels software-based representative image sampling.

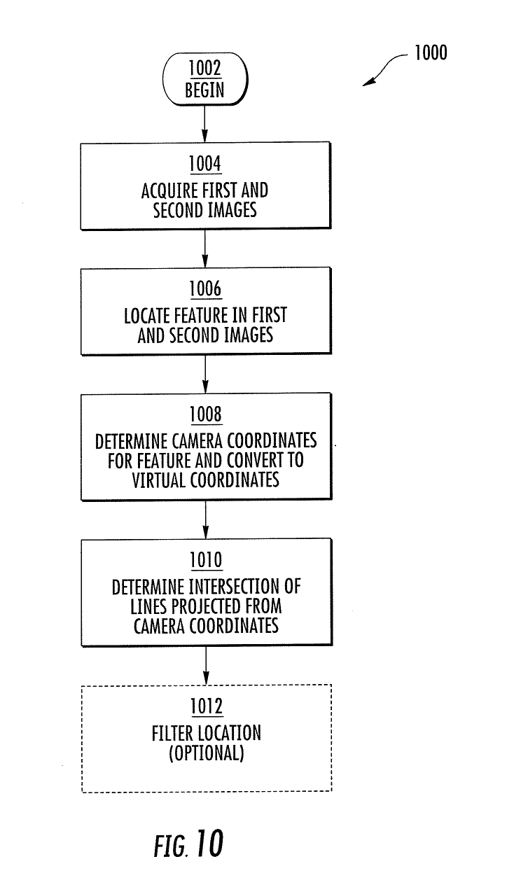

FIG. 9 is a timing diagram 900 showing another sampling routine that can be used by a position detection system. This example features a higher modulation rate and rapid shuttering, with each row sampled during a given on-off cycle. The total exposure time for the frame can equal or approximately equal the number of rows multiplied by the time for a complete modulation cycle.

### Illustrative Embodiments of Coordinate Detection

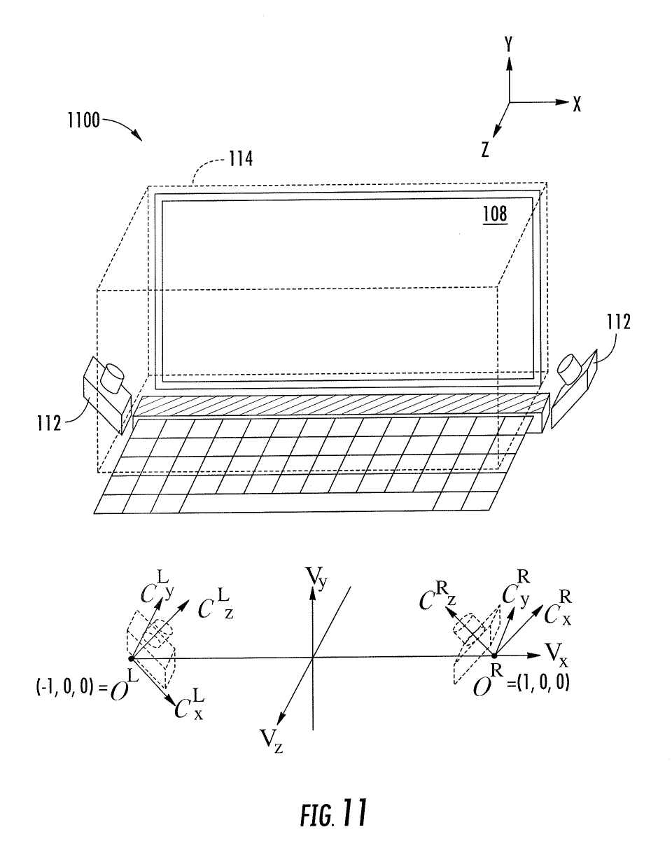

FIG. 10 is a flowchart showing steps in an exemplary method 1000 for detecting one or more space coordinates. For example, a position detection system such as one of the systems of FIGS. 1A-1D may feature a plurality of imaging devices that are used to image a space and carry out a method in accordance with FIG. 10. Another example is shown at 1100 in FIG. 11. In this example, first and second imaging devices 112 are positioned proximate a display 108 and keyboard and are configured to image a space 114. In this example, space 114 corresponds to a rectangular space between display 108 and the keyboard.

FIG. 11 also shows a coordinate system V (Vₓ, V_{y}, V_{z}) defined with respect to area 114, with the space coordinate(s) determined in terms of V. Each imaging device 112 also features its own coordinate system C defined relative to an origin of each respective camera (shown as O^{L} and O^{R} in FIG. 11), with O^{L} defined as (−1, 0, 0) in coordinate system V and O^{R} defined as (1, 0, 0) in coordinate system V. For the left-side camera, camera coordinates are specified in terms of (C^{L}ₓ, C^{L}_{y}, C^{L}_{z}) while right-side camera coordinates are specified in terms of (C^{R}ₓ, C^{R}_{y}, C^{R}_{z}). The x- and y-coordinate in each camera correspond to X and Y coordinates for each unit, while the z-coordinate (C^{L}_{z} and C^{R}_{z}) is the normal or direction of the plane of the imaging unit in this example.

Back in FIG. 10, beginning at block 1002, the method moves to block 1004, which represents acquiring first and second images. In some embodiments, acquiring the first and second image comprises acquiring a first difference image based on images from a first imaging device and acquiring a second difference image based on images from the second imaging device.

Each difference image can be determined by subtracting a background image from a representative image. In particular, while a light source is modulated, each of a first and a second imaging device can image the space while lit and while not lit. The first and second representative images can be determined by subtracting the unlit image from each device from the lit image from each device (or vice-versa, with the absolute value of the image taken). As another example, the imaging devices can be configured with hardware in accordance with FIGS. 7-9 or in another suitable manner to provide a representative image based on modulation of the light source.

In some embodiments, the representative images can be used directly. However, in some embodiments the difference images can be obtained by subtracting a respective background image from each of the representative images so that the object whose feature(s) are to be identified (e.g., the finger, stylus, etc.) remains but background features are absent.

For example, in one embodiment a representative image is defined as

Iₜ=|Imₜ−Imₜ₋₁|

where Imₜ represents the output of the imaging device at imaging interval t.

A series of representative images can be determined by alternatively capturing lit and unlit images to result in I₁, I₂, I₃, I₄, etc. Background subtraction can be carried out by first initializing a background image B₀=I₁. Then, the background image can be updated according to the following algorithm:

### If Iₜ[n]>Bₜ₋₁[n],

### Then Bₜ[n]=Bₜ₋₁[n]+1;

### Else Bₜ[n]=Iₜ[n]

As another example, the algorithm could be:

### If Iₜ[n]>Bₜ₋₁[n],

### Then Bₜ[n]=Bₜ₋₁[n]+1;

### Else Bₜ[n]=Bₜ[n]−1

The differential image can be obtained by:

Dₜ=Iₜ−Bₜ

Of course, various embodiments can use any suitable technique to obtain suitable images. In any event, after the first and second images are acquired, the method moves to block 1006, which represents locating a feature in each of the first and second images. In practice, multiple different features could be identified, though embodiments can proceed starting from one common feature. Any suitable technique can be used to identify the feature, including an exemplary method noted later below.

Regardless of the technique used to identify the feature, the feature will be located in terms of two-dimensional image pixel coordinates I (I^{L}ₓ, I^{L}_{y}) and (I^{R}ₓ, I^{R}_{y}) in each of the acquired images. Block 1008 represents determining camera coordinates for the feature and then converting the coordinates to virtual coordinates. Image pixel coordinates can be converted to camera coordinates C (in mm) using the following expression:

$$( \begin{matrix}{C}_{x} \\ {C}_{y} \\ {C}_{z}\end{matrix} ) = ( \begin{matrix}( {I}_{x} - {P}_{x} ) / {f}_{x} \\ ( {I}_{y} - {P}_{y} ) / {f}_{y} \\ 1\end{matrix} )$$

where (Pₓ, P_{y}) is the principle center and fₓ, f_{y} are the focal lengths of each camera from calibration.

Coordinates from left imaging unit coordinates C^{L} and right imaging unit coordinates C^{R} can be converted to corresponding coordinates in coordinate system V according to the following expressions:

V^{L}=M_{Left}×C^{L}

V^{R}=M_{right}×C^{R}

where M_{left} and M_{right} are the transformation matrices from left and right camera coordinates to the virtual coordinates; M_{left} and M_{right} can be calculated by the rotation matrix, R, and translation vector T from stereo camera calibration. A chessboard pattern can be imaged by both imaging device and used to calculate a homogenous transformation between cameras in order to derive a rotation matrix R and translation vector T. In particular, assuming P^{R} is a point in the right camera coordinate system and point P^{L} is a point in the left camera coordinate system, the transformation from right to left can be defined as P^{L}=R·P^{R}+T.

As before, the origins of the cameras can be set along the x-axis of the virtual space, with the left camera origin at (−1, 0, 0) and the right camera origin at (0, 0, 1). In this example, the x-axis of the virtual coordinate, Vₓ, is defined along the origins of the cameras. The z-axis of the virtual coordinate, V_{z}, is defined as the cross product of the z-axes from the camera's local coordinates (i.e. by the cross product of C^{L}_{z} and C^{R}_{z}). The y-axis of the virtual coordinate, V_{y}, is defined as the cross product of the x and z axes.

With these definitions and the calibration data, each axis of the virtual coordinate system can be derived according to the following steps:

Vₓ=R·[0,0,0]^{T}+T

V_{z}=((R·[0,0,1]^{T}=T)−Vₓ)×[0,0,1]^{T}

V_{y}=V_{z}×Vₓ

V_{z}=Vₓ×V_{y}

V_{z}, is calculated twice in case C_{z}^{L} and C_{z}^{R} are not co-planar. Because the origin of the left camera is defined at [−1, 0, 0]^{T} the homogenous transformation of points from the left camera coordinate to the virtual coordinate can be obtained using the following expression; similar computations can derive the homogonous transformation from the right camera coordinate to the virtual coordinate:

M_{left}=[Vₓ^{T}V_{y}^{T}V_{z}^{T}[−1,0,0,1]^{T}]

And

M_{right}=└R×Vₓ^{T}R×V_{y}^{T}R×V_{z}^{T}[1,0,0,1]┘

Block 1010 represents determining an intersection of a first line and a second line. The first line is projected from the first camera origin and through the virtual coordinates of the feature as detected at the first imaging device, while the second line is projected from the second camera origin and through the virtual coordinates of the feature as detected at the second imaging device.

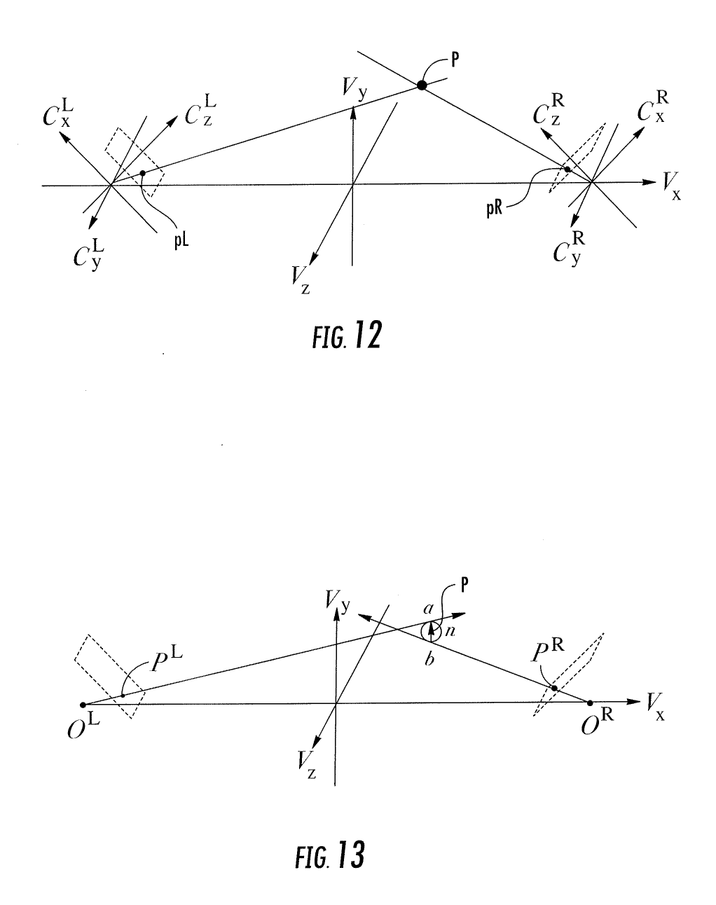

As shown in FIGS. 12-13, the feature as detected has a left-side coordinate P^{L} in coordinate system V and a right-side coordinate P^{R} in coordinate system V. A line can be projected from left-side origin O^{L} through P^{L} and from right-side origin O^{R} through P^{R}. Ideally, the lines will intersect at or near a location corresponding to the feature as shown in FIG. 12.

In practice, a perfect intersection may not be found—for example the projected lines may not be co-planar due to errors in calibration. Thus, in some embodiments the intersection point P is defined as the center of the smallest sphere to which both lines are tangential. As shown in FIG. 13, the sphere n is tangential to the projected lines at points a and b and thus the center of sphere n is defined as the space coordinate. The center of the sphere can be calculated by:

O^{L}+(P^{L}−O^{L})·t^{L}=P+λ·n

O^{R}+(P^{R}−O^{R})·t^{R}=P−λ·n

where n is a unit vector from nodes b to a and is derived from the cross product of two rays (P^{L}−O^{L})×(P^{R}−O^{R}). The three remaining unknowns, t^{L}, t^{R}, and λ, can be derived from solving the following linear equation:

$$[ {t}^{L} {t}^{R} λ ] \cdot [ \begin{matrix}( {P}^{L} - {O}^{L} \\ - ( {P}^{R} - {O}^{R} ) \\ - 2 n\end{matrix} ] = {O}^{R} - {O}^{L}$$

Block 1012 represents an optional step of filtering the location P. The filter can be applied to eliminate vibration or minute movements in the position of P. This can minimize unintentional shake or movement of a pointer or the object being detected. Suitable filters include an infinite impulse response filter, a GHK filter, etc., or even a custom filter for use with the position detection system.

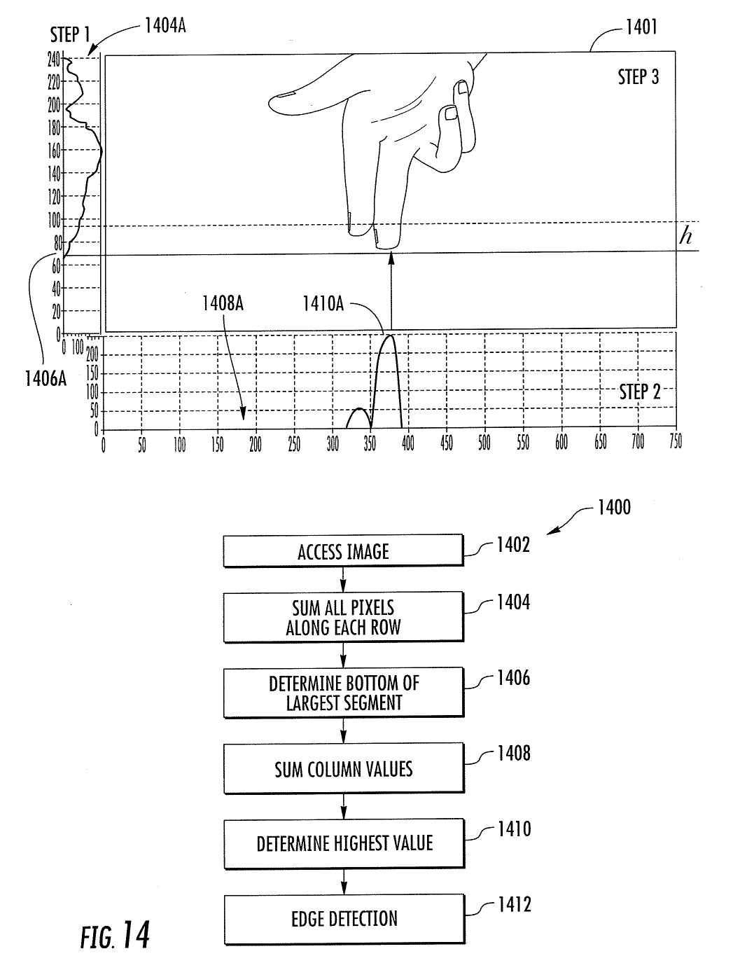

As noted above, a space coordinate P can be found based on identifying a feature as depicted in at least two images. Any suitable image processing technique can be used to identify the feature. An example of an image processing technique is shown in FIG. 14, which is a flowchart and accompanying diagram showing an illustrative method 1400 of identifying a fingertip in an image. Diagram 1401 depicts an example of a difference image under analysis according to method 1400.

Block 1402 represents accessing the image data. For example, the image may be retrieved directly from an imaging device or memory or may be subjected to background subtraction or other refinement to aid in the feature recognition process. Block 1404 represents summing the intensity of all pixels along each row and then maintaining a representation of the sum as a function of the row number. An example representation is shown as plot 1404A. Although shown here as a visual plot, an actual plot does not need to be provided in practice and the position detection system can instead rely on an array of values or another in-memory representation.

In this example, the cameras are assumed to be oriented as shown in FIG. 11. Thus, the camera locations are fixed and a user of the system is presumed to enter space 114 using his or her hand (or another object) from the front side. Therefore, the pixels at the pointing fingertip should be closer to the screen than any other pixels. Accordingly, this feature recognition method identifies an image coordinate [Iₓ, I_{y}] as corresponding to the pointing fingertip when the coordinate lies at the bottom of the image.

Block 1406 represents determining the bottom row of the largest segment of rows. In this example, the bottom row is shown at 1406 in the plot and only a single segment exists. In some situations, the summed pixel intensities may be discontinuous due to variations in lighting, etc., and so multiple discontinuous segments could occur in plot 1404A; in such cases the bottommost segment is considered. The vertical coordinate I_{y} can be approximated as the row at the bottommost segment.

Block 1408 represents summing pixel intensity values starting from I_{y} for columns of the image. A representation of the summed intensity values as a function of the column number is shown at 1408A, though as mentioned above in practice an actual plot need not be provided. In some embodiments, the pixel intensity values are summed only for a maximum of h pixels from I_{y}, with h equal to 10 pixels in one embodiment. Block 1410 represents approximating the horizontal coordinate Iₓ of the fingertip can be approximated as the coordinate for the column having the largest value of the summed column intensities; this is shown at 1410A in the diagram.

The approximated coordinates [I_{X}, I_{y}] can be used to determine a space coordinate P according to the methods noted above (or any other suitable method). However, some embodiments proceed to block 1412, which represents one or more additional processing steps such as edge detection. For example, in one embodiment a Sobel edge detection is performed around [I_{X}, I_{y}] (e.g., in a 40×40 pixel window) and a resulting edge image is stored in memory, with strength values for the edge image used across the entire image to determine edges of the hand. A location of the first fingertip can be defined as the pixel on the detected edge that is closest to the bottom edge of the image, and that location can be used in determining a space coordinate. Still further, image coordinates of the remaining fingertips can be detected using suitable curvature algorithms, with corresponding space coordinates determined based on image coordinates of the remaining fingertips.

In this example the feature was recognized based on an assumption of a likely shape and orientation of the object in the imaged space. It will be understood that the technique can vary for different arrangements of detectors and other components of the position detection system. For instance, if the imaging devices are positioned differently, then the most likely location for the fingertip may be the topmost row or the leftmost column, etc.

### Illustrative Aspects of Position Detection Systems Utilizing Interactive Volumes

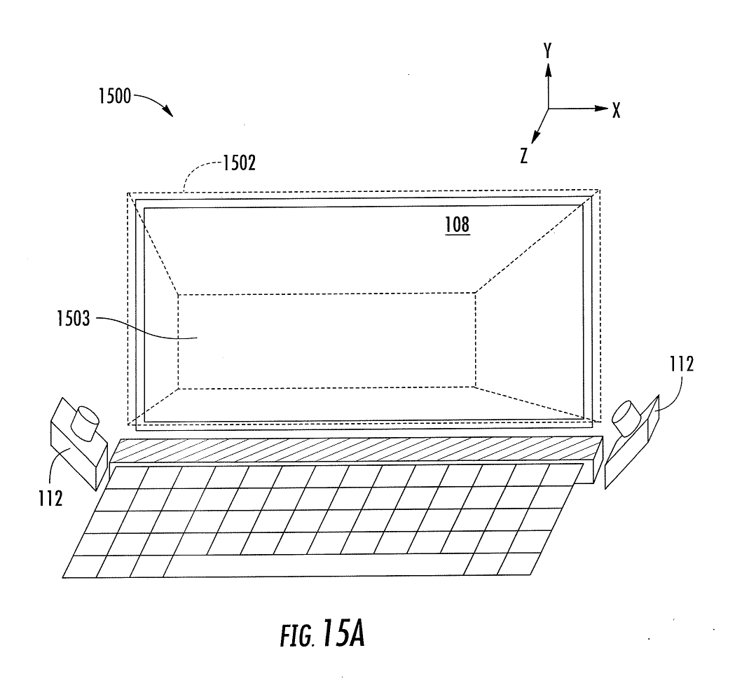

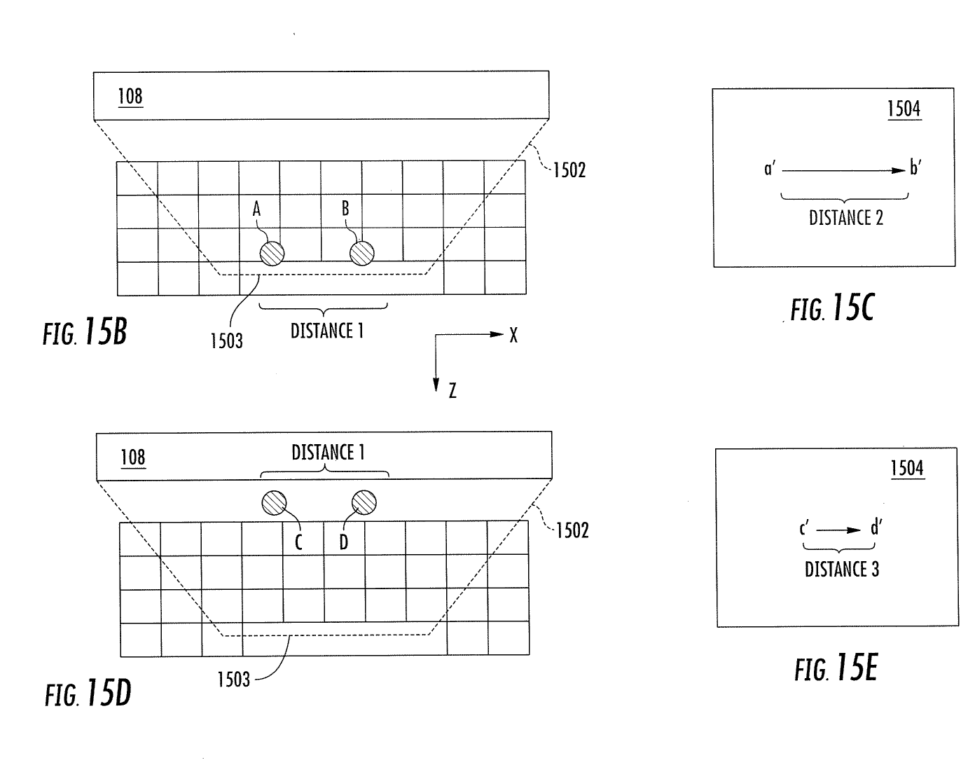

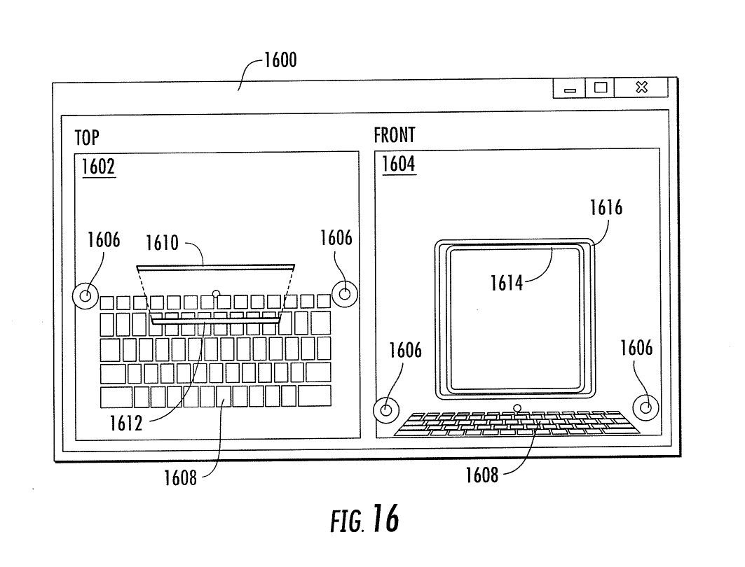

FIG. 15A illustrates use of an interactive volume in a position detection system. In some embodiments, the processor(s) of a position detection system are configured to access data from the at least one imaging device, the data comprising image data of an object in the space, access data defining at least one interactive volume within the space, determine a space coordinate associated with the object, and determine a command based on the space coordinate and the interactive volume. The interactive volume is a three-dimensional geometrical object defined in the field of view of the imaging device(s) of the position detection system.

FIG. 15A shows a position detection system 1500 featuring a display 108 and imaging devices 112. The space imaged by devices 112 features an interactive volume 1502, shown here as a trapezoidal prism. It will be understood that in various embodiments one or more interactive volumes can be used and the interactive volume(s) may be of any desired shape. In this example, interactive volume 1502 defines a rear surface at or near the plane of display 108 and a front surface 1503 extending outward in the z+ direction. Corners of the rear surface of the interactive volume are mapped to corresponding corners of the display in this example, and a depth is defined between the rear and front surfaces.

For best results, this mapping uses data regarding the orientation of the display—such information can be achieved in any suitable manner. As one example, an imaging device with a field of view of the display can be used to monitor the display surface and reflections thereon. Touch events can be identified based on inferring a touch surface from viewing an object and reflection of the object, with three touch events used to define the plane of the display. Of course, other techniques could be used to determine the location/orientation of the display.

In some embodiments, the computing device can determine a command by determining a value of an interface coordinate using a space coordinate and a mapping of coordinate values within the interactive volume to interface coordinates in order to determine at least first and second values for the interface coordinate.

Although a pointer could simply be mapped from a 3D coordinate to a 2D coordinate (or to a 2D coordinate plus a depth coordinate, in the case of a three-dimensional interface), embodiments also include converting the position according to a more generalized approach. In particular, the generalized approach effectively allows for the conversion of space coordinates to interface coordinates to differ according to the value of the space coordinate, with the result that movement of an object over a distance within a first section of the interactive volume displaces a cursor by an amount less than (or more than) movement of the object over an identical distance within the second section.

FIGS. 15B-E illustrate one example of the resulting cursor displacement. FIG. 15B is a top view of the system shown in FIG. 15A showing the front and sides of interactive volume 1502 in cross-section. An object such as a finger or stylus is moved from point A to point B along distance1, with the depth of both points A and B being near the front face 1503 of interactive volume 1502. FIG. 15C shows corresponding movement of a cursor from point a′ to point b′ over distance1.

FIG. 15D again shows the cross sectional view, but although the object is moved from point C to point D along the same distance1 along the x-axis, the movement occurs at a depth much closer to the rear face of interactive volume 1502. The resulting cursor movement is shown in FIG. 15E where the cursor moves distance3 from point c′ to d′.

In this example, because the front face of the interactive volume is smaller than the rear face of the interactive volume, a slower cursor movement results for a given movement in the imaged space as the movement occurs closer to the screen. A movement in a first cross-sectional plane of the interactive volume can result in a set of coordinate values that differ than the same movement if made in a second cross-sectional plane. In this example, the mappings varied along the depth of the interactive volume but similar effects could be achieved in different directions through use of other mappings.

For example, a computing system can support a state in which the 3D coordinate detection system is used for 2D input. In some implementations this is achieved by using an interactive volume with a short depth (e.g., 3 cm) and a one-to-one mapping to screen coordinates. Thus, movement within the virtual volume can be used for 2D input, such as touch- and hover-based input commands. For instance, the click can be identified when the rear surface of the interactive volume is reached.

Although this example depicted cursor movement, the effect can be used in any situation in which coordinates or other commands are determined based on movement of an object in the imaged space. For example, if three-dimensional gestures are identified, then the gestures may be at a higher spatial resolution at one part of the interactive volume as compared to another. As a specific example, if the interactive volume shown in FIG. 15A is used, a “flick” gesture may have higher magnitude at a location farther from the screen than if the same gesture were made closer to the screen.

In addition to varying mapping of coordinates along the depth (and/or another axis of the interactive volume), the interactive volume can be used in other ways. For example, the rear surface of the interactive volume can be defined as the plane of the display or even outward from the plane of the display so that when the rear surface of the interactive volume is reached (or passed) a click or other selection command is provided at the corresponding interface coordinate. More generally, an encounter with any boundary of the interactive volume could be interpreted as a command.

In one embodiment, the interface coordinate is determined as a pointer position P according to the following trilinear interpolation:

P=P₀·(1−ξₓ)·(1−ξ_{y})·(1−ξ_{z})+P₁·ξₓ·(1−ξ_{y})·(1−ξ_{z})+P₂·(1−ξₓ)·ξ_{y}·(1−ξ_{z})+P₃·ξ_{x·ξ}_{y}·(1−ξ_{z})+P₄·(1−ξₓ)·(1−ξ_{y})·ξ_{z}+P₅·ξₓ·(1−ξ_{y})·ξ_{z}+P₆·(1−ξₓ)·ξ_{y}·ξ_{z}+P₇·ξₓ·ξ_{y}·ξ_{z}

where the vertices of the interactive volume are P_{[0-7]} and ξ=[ξₓ,ξ_{y},ξ_{z}] is the determined space coordinate in the range of [0, 1].

Of course, other mappings could be used to achieve the effects noted herein and the particular interpolation noted above is for purposes of example only. Still further, other types of mappings could be used. As an example, a plurality of rectangular sections of an imaged area can be defined along the depth of the imaged area. Each rectangular section can have a different x-y mapping of interface coordinates to space coordinates.

Additionally, the interactive volume need not be a trapezoid—a rhombic prism could be used or an irregular shape could be provided. For example, an interactive volume could be defined so that x-y mapping varies according to depth (i.e. z-position) and/or x-z mapping varies according to height (i.e. y-position) and/or y-z mapping varies according to width (i.e., x-position). The shapes and behavior of the interactive volume here have been described with respect to a rectangular coordinate system but interactive volumes could be defined in terms of spherical or other coordinates, subject to the imaging capabilities and spatial arrangement of the position detection system.

In practice, the mapping of space coordinates to image coordinates can be calculated in real time by carrying out the corresponding calculations. As another example, an interactive volume can be implemented as a set of mapped coordinates calculated as a function of space coordinates, with the set stored in memory and then accessed during operation of the system once a space coordinate is determined.

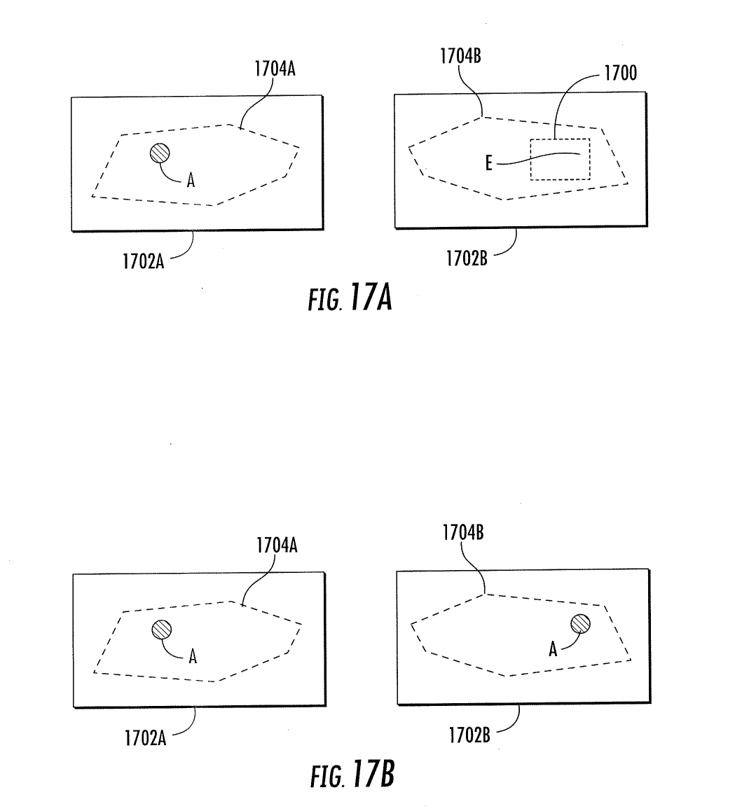

In some embodiments the size, shape, and/or position of the interactive volume can be adjusted by a user. This can allow the user to define multiple interactive volumes (e.g., for splitting the detectable space into sub-areas for multiple monitors) and to control how space coordinates are mapped to screen coordinate. FIG. 16 is an example of a graphical user interface 1600 that can be provided by a position detection system. In this example, interface 1600 provides a top view 1602 and a front view 1604 showing the relationship of the interactive volume to the imaging devices (represented as icons 1606) and the keyboard (represented as a graphic 1608). A side view could be provided as well.

By dragging or otherwise manipulating elements 1620, 1622, 1624, and 1626, a user can adjust the size and position of the front and rear faces of the interactive volume. Additional embodiments may allow the user to define more complex interactive volumes, split the area into multiple interactive volumes, etc. This interface is provided for purposes of example only; in practice any suitable interface elements such as sliders, buttons, dialog boxes, etc. could be used to set parameters of the interactive volume. If the mapping calculations are carried out in real time or near real time, the adjustments in the interface can be used to make corresponding adjustments to the mapping parameters. If a predefined set is used, the interface can be used to select another pre-defined mapping and/or the set of coordinates can be calculated and stored in memory for use in converting space coordinates to interface coordinates.

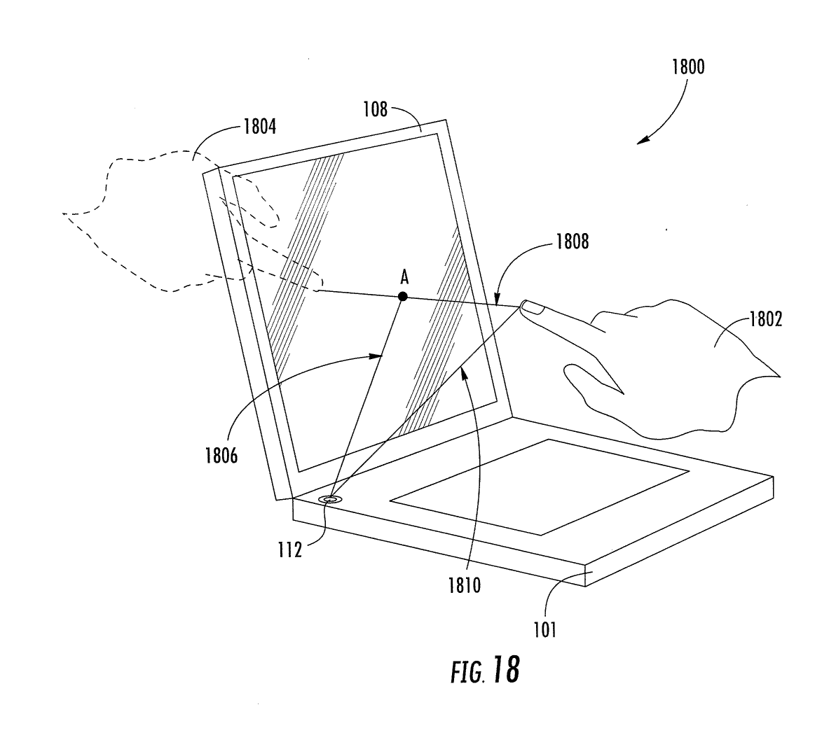

The interactive volume can also be used to enhance image processing and feature detection. FIGS. 17A-B show use of one array of pixels 1702A from a first imaging device and a second array of pixels 1702B from a second imaging device. In some embodiments, the processing device of the position detection system is configured to iteratively sample image data of the at least one imaging device and determine a space coordinate associated with an object in the space based on detecting an image of a feature of the object in the image data as noted above. Iteratively sampling the image data can comprise determining a range of pixels for use in sampling image data during the next iteration based on a pixel location of a feature during a current iteration. Additionally or alternatively, iteratively sampling can comprise using data regarding a pixel location of a feature as detected by one imaging device during one iteration to determine a range of pixels for use in locating the feature using another imaging device during that same iteration (or another iteration).

As shown in FIG. 17A, a window 1700 of pixels is used, with the location of window 1700 updated based on the location of detected feature A. For example, during a first iteration (or series of iterations) feature A can be identified by sampling both arrays 1702A and 1702B, with feature A appearing in each; FIG. 17B shows feature A as it appears in array 1702B. However, once an initial location of feature A has been determined, window 1700 can be used to limit the area sampled in at least one of the arrays of pixels or, if the entire array is sampled, to limit the extent of the image searched during the next iteration.

For example, after a fingertip or other feature is identified, its image coordinates are kept in static memory so that detection in the next frame only passes a region of pixels (e.g., 40×40 pixels) around the stored coordinate for processing. Pixels outside the window may not be sampled at all or may be sampled at a lower resolution than the pixels inside the window. As another example, a particular row may be identified for use in searching for the feature.

Additionally or alternatively, in some embodiments the interactive volume is used in limiting the area searched or sampled. Specifically, the interactive volume can be projected onto each camera's image plane as shown at 1704A and 1704B to define one or more regions within each array of pixels. Pixels outside the regions can be ignored during sampling and/or analysis to reduce the amount of data passing through the image processing steps or can be processed at a lower resolution than pixels inside the interactive volume.

As another example, a relationship based on epipolar geometry for stereo vision can be used to limit the area searched or sampled. A detected fingertip in the first camera, e.g., point A in array 1702A, has a geometrical relationship to pixels in the second camera (e.g., array 1702B) found by running a line from the origin of the first camera through the detected fingertip in 3-D space. This line will intersect with the interactive volume in a 3D line space. The 3D line space can be projected onto the image plane of the other camera (e.g., onto array 1702B) resulting in a 2D line segment (epipolar line) E that can be used in searching. For instance, pixels corresponding to the 2D line segment can be searched while the other pixels are ignored. As another example, a window along the epipolar line can be searched for the feature. The depiction of the epipolar line in this example is purely for purposes of illustration, in practice the direction and length of the line will vary according to the geometry of the system, location of the pointer, etc.

In some embodiments, the epipolar relationship is used to verify that the correct feature has been identified. In particular, the detected point in the first camera is validated if the detected point is found along the epipolar line in the second camera.

Embodiments with Enhanced Recognition Capability

As noted above some embodiments determine one or more space coordinates and use the space coordinate(s) in determining commands for a position detection system. Although the commands can include movement of a cursor position, hovers, clicks, and the like, the commands are not intended to be limited to only those cases. Rather, additional command types can be supported due to the ability to image objects, such as a user's hand, in space.

For example, in one embodiment multiple fingertips or even a hand model can be used to support 3D hand gestures. For example, discriminative methods can be used to recover the hand gesture from a single frame through classification or regression techniques. Additionally or alternatively generative methods can be used to fit a 3D hand model to the observed images. These techniques can be used in addition to or instead of the fingertip recognition technique noted above. As another example, fingertip recognition/cursor movement may be defined within a first observable zone while 3D and/or 2D hand gestures may be recognized for movement in one or more other observable zones.

### Use of Multiple States in Position Detection Systems

In some embodiments the position detection system uses a first set of pixels for use in sampling image data during a first state and a second set of pixels for use in sampling image data during a second state. The system can be configured to switch between the first and second states based on success or failure in detecting a feature in the image data. As an example, if a window, interactive volume, and/or epipolar geometry are used in defining a first set of pixels but the feature is not found in both images during an iteration, the system may switch to second state that uses all available pixels.

Additionally or alternatively, states may be used to conserve energy and/or processing power. For example, in a “sleep” state one or more imaging devices are deactivated. One imaging device can be used to identify motion or other activity or another sensor can be used to toggle from the “sleep” state to another state. As another example, the position detection system may operate one or more imaging device using alternating rows or sets of rows during one state and switch to continuous rows in another state. This may provide enough detection capability to determine when the position detection system is to be used while conserving resources at other times. As another example, one state may use only a single row of pixels to identify movement and switch to another state in which all rows are used. Of course, when “all” rows are used one or more of the limiting techniques noted above could be applied.

States may also be useful in conserving power by selectively disabling irradiation components. For example, when running on batteries in portable devices it is a disadvantage to provide IR light on a continuous basis. Therefore, in some implementations, the default mode of operation is a low-power mode during which the position detection system is active but the irradiation components are deactivated. One or more imaging devices can act as proximity sensors using ambient light to determine whether to activate the IR irradiation system (or other irradiation used for position detection purposes). In other implementations, another type of proximity sensor could be used, of course. The irradiation system can be operated at full power until an event, such as lack of movement for a predetermined period of time.

In one implementation, an area camera is used as a proximity sensor. Returning to the example of FIG. 2, during a low-power mode, anything entering one of the zones (zone 3, for example) detected with ambient light will cause the system to fully wake up. During the low-power mode, detection of objects entering the zone can be done at a much reduced frame rate, typically at 1 Hz, to further save power.

Additional power reduction measures can be used as well. For example, a computing device used with the position detection system may support a “sleep mode.” During sleep mode, the irradiation system is inactive and only one row of pixels from one camera is examined. Movement can be found by measuring if any block of pixels significantly change in intensity at over a 1 or 2 second time interval or by more complex methods used to determine optical flow (e.g., phase correlation, differential methods such as Lucas-Kanade, Horn-Schunk, and/or discrete optimization methods). If motion is detected, then one or more other cameras of the position detection system can be activated to see if the object is actually in the interaction zone and not further out and, if an object is indeed in the interaction zone, the computing device can be woken from sleep mode.

### Touch Detection

As noted above, a position detection system can respond to 2D touch events. A 2D touch event can comprise one or more contacts between an object and a surface of interest. FIG. 18 shows an example 1800 of a computing system that provides for position detection in accordance with one or more of the examples above. Here, the system includes a body 101, display 108, and at least one imaging device 112, though multiple imaging devices could be used. The imaged space includes a surface, which in this example corresponds to display 108 or a material atop the display. However, implementations may have another surface of interest (e.g., body 101, a peripheral device, or other input area) in view of imaging device(s) 112.

In some implementations, determining a command comprises identifying whether a contact is made between the object and the surface. For example, a 3D space coordinate associated with a feature of object 1802 (in this example, a fingertip) can be determined using one or more imaging devices. If the space coordinate is at or near a surface of display 108, then a touch command may be inferred (either based on use of an interactive volume or some other technique).

### Single Camera Coordinate Determination

In some implementations, the surface is at least partially reflective and determining the space coordinate is based at least in part on image data representing a reflection of the object. For example, as shown in FIG. 18, object 1802 features a reflected image 1804. Object 1802 and reflected image 1804 can be imaged by imaging device 112. A space coordinate for the fingertip of object 1802 can be determined based on object 1802 and its reflection 1804, thereby allowing for use of a single camera to determine 3D coordinates.

For example, in one implementation, the position detection system searches for a feature (e.g., a fingertip) in one image and, if found, searches for a reflection of that feature. An image plane can be determined based on the image and its reflection. The position detection system may determine if a touch is in progress based on the proximity of the feature and its reflection—if the feature and its reflection coincide or are within a threshold distance of one another, this may be interpreted as a touch.

Regardless of whether a touch occurs, a coordinate for point “A” between the fingertip and its reflection can determined based on the feature and its reflection. The location of the reflective surface (screen 108 in this example) is known from calibration (e.g., through three touches or any other suitable technique), and it is known that “A” must lie on the reflective surface.

The position detection system can project a line 1806 from the camera origin, through the image plane coordinate corresponding to point “A” and determine where line 1806 intersects the plane of screen 108 to obtain 3D coordinates for point “A.” Once the 3D coordinate for “A” is known, a line 1808 normal to screen 108 can be projected through A. A line 1810 can be projected from the camera origin through the fingertip as located in the image plane. The intersection of lines 1808 and 1810 represents the 3D coordinate of the fingertip (or the 3D coordinate of its reflection—the two can be distinguished based on their coordinate values to determine which one is in front of screen 108).

Additional examples of using a single camera for 3D position detection can be found in U.S. patent application Ser. No. 12/704,949, filed Feb. 12, 2010 naming Bo Li and John Newton as inventors, which is incorporated by reference herein in its entirety.

In some implementations, a plurality of imaging devices are used, but a 3D coordinate for a feature (e.g., the fingertip of object 1802) is determined using each imaging device alone. Then, the images can be combined using stereo matching techniques and the system can attempt to match the fingertips from each image based on their respective epipolar lines and 3D coordinates. If the fingertips match, an actual 3D coordinate can be found using triangulation. If the fingertips do not match, then one view may be occluded, so the 3D coordinates from one camera can be used.

For example, when detecting multiple contacts (e.g., two fingertips spaced apart), the fingertips as imaged using multiple imaging devices can be overlain (in memory) to determine finger coordinates. If one finger is occluded from being viewed by each imaging device, then a single-camera method can be used. The occluded finger and its reflection can be identified and then a line projected between the finger and its reflection—the center point of that line can be treated as the coordinate.

### General Considerations

Examples discussed herein are not meant to imply that the present subject matter is limited to any specific hardware architecture or configuration discussed herein. As was noted above, a computing device can include any suitable arrangement of components that provide a result conditioned on one or more inputs. Suitable computing devices include multipurpose and specialized microprocessor-based computer systems accessing stored software, but also application-specific integrated circuits and other programmable logic, and combinations thereof. Any suitable programming, scripting, or other type of language or combinations of languages may be used to construct program components and code for implementing the teachings contained herein.

Embodiments of the methods disclosed herein may be executed by one or more suitable computing devices. Such system(s) may comprise one or more computing devices adapted to perform one or more embodiments of the methods disclosed herein. As noted above, such devices may access one or more computer-readable media that embody computer-readable instructions which, when executed by at least one computer, cause the at least one computer to implement one or more embodiments of the methods of the present subject matter. When software is utilized, the software may comprise one or more components, processes, and/or applications. Additionally or alternatively to software, the computing device(s) may comprise circuitry that renders the device(s) operative to implement one or more of the methods of the present subject matter.

Any suitable non-transitory computer-readable medium or media may be used to implement or practice the presently-disclosed subject matter, including, but not limited to, diskettes, drives, magnetic-based storage media, optical storage media, including disks (including CD-ROMS, DVD-ROMS, and variants thereof), flash, RAM, ROM, and other memory devices, and the like.

Examples of infrared (IR) irradiation were provided. It will be understood that any suitable wavelength range(s) of energy can be used for position detection, and the use of IR irradiation and detection is for purposes of example only. For example, ambient light (e.g., visible light) may be used in addition to or instead of IR light.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed:

1. A computing system, comprising:
a processor;
a memory; and
at least one imaging device configured to image a space,
wherein the memory comprises at least one program component that configures the processor to:
access data from the at least one imaging device, the data comprising image data of an object in the space,
access data defining an interactive volume within the space,
determine a space coordinate associated with the object, and
determine a command based on the space coordinate and the interactive volume.

2. The computing system set forth in claim 1, wherein determining the command comprises determining a value of an interface coordinate of the object or portion of the object, the interface coordinate determined using the space coordinate and a mapping, the mapping relating space coordinate values to interface coordinate values.

3. The computing system set forth in claim 2, wherein an interface coordinate comprises a two-dimensional screen coordinate having first and second values used to specify a position in a graphical user interface.

4. The computing system set forth in claim 2,
wherein the mapping of coordinates within the interactive volume to the interface coordinates maps space coordinate values laying within a first plane included in the interactive volume to a first set of interface coordinates, and
wherein the mapping of coordinates within the interactive volume to the interface coordinates maps space coordinate values laying a second plane included in the interactive volume to a second set of interface coordinates.

5. The computing system set forth in claim 4, wherein the interactive volume defines a rear surface, a front surface, and a depth between the rear and front surface,
wherein the mapping of coordinates within the interactive volume to the interface coordinate system differs along the depth.

6. The computing system set forth in claim 5,
wherein the interactive volume comprises a plurality of rectangular sections along the depth, each corner of each of the plurality of sections mapped to a corner of a graphical user interface, the sections differing in at least one of a width and a height, and
wherein a mapping of coordinates along at least one of the width or height within a first section of the plurality of sections differs from a mapping of coordinates along at least one of the width or height within a second section of the plurality of sections.

7. The computing system set forth in claim 6, wherein the mappings differ so that movement of an object over a distance within the first section displaces a cursor by an amount less than movement of the object over an identical distance within the second section.

8. The computing system set forth in claim 1,
wherein the interactive volume defines a rear surface and a front surface, and
wherein the command is an input identified when space coordinate reaches or passes the rear surface.

9. The computing system set forth in claim 8, wherein the command comprises a click event at a two-dimensional screen coordinate mapped to the rear surface of the interactive volume.

10. The computing system set forth in claim 8, wherein the interactive volume defines at least a first side opposite a second side.

11. The computing system set forth in claim 1, wherein the at least one program component configures the processor to provide output for use in rendering a display and to provide an interface, the interface configured to receive input adjusting at least one of a size or position of the interactive volume with respect to the display, and
wherein the data defining an interactive volume within the space is defined in response to the received input.

12. The computing system set forth in claim 11, further comprising at least one display,
wherein the interactive volume defines a front face and a rear face, and
wherein the rear face corresponds to a size of a display area defined by the at least one display.

13. A computer-implemented method, comprising:
obtaining, by a position detection system, image data of an object in a space, the image data provided by at least one imaging sensor;
accessing, by the position detection system, data defining an interactive volume within the space;
determining, by the position detection system, a space coordinate associated with the object; and
determining, by the position detection system, a command based on the space coordinate and the interactive volume.

14. The method set forth in claim 13, wherein determining the command comprises determining a value of an interface coordinate of the object or portion of the object, the interface coordinate determined using the space coordinate and a mapping of coordinates within the interactive volume to an interface coordinates.

15. The method set forth in claim 14, wherein the interface coordinate value comprises a two-dimensional screen coordinate having first and second values used to specify a position in a graphical user interface.

16. The method set forth in claim 15, wherein determining the command further comprises determining a third value of the coordinate.

17. The method set forth in claim 16,
wherein the interactive volume defines a front surface, rear surface, and a depth between the front and rear surfaces, and
wherein the mapping of coordinates within the interactive volume to the interface coordinates differs along the depth of the interactive volume.

18. The method set forth in claim 13,
wherein the interactive volume defines a rear surface and a front surface, and
wherein determining the command comprises identifying an input event when the space coordinate reaches or passes the rear surface.

19. The method set forth in claim 18, wherein the input event comprises a click event at a two-dimensional screen coordinate mapped to the rear surface of the interactive volume.

20. The method set forth in claim 13, further comprising:
displaying a user interface using at least one display device defining a display area,
wherein the interactive volume defines a rear surface and a front surface and the rear surface corresponds to the display area defined by the at least one display device.

21. The method set forth in claim 13, wherein the interactive volume defines a rear surface and a front surface, the rear surface and front surface having identical sizes.

22. The method set forth in claim 13, wherein the interactive volume defines a rear surface and a front surface having different sizes.

23. The method set forth in claim 13, further comprising:
providing an interface, the interface configured to receive input adjusting at least one of a size, a shape, or a position of the interactive volume relative to a component of the computing system.

24. A computer program product comprising a computer-readable medium embodying program code executable by a computing device, the program code comprising:
code that configures the computing device to obtain image data of an object in a space, the image data provided by at least one imaging sensor;
code that configures the computing device to access data defining an interactive volume within the space;
code that configures the computing device to determine a space coordinate associated with the object; and
code that configures the computing device to determine a command based on the space coordinate and the interactive volume.
